(19) United States
(12) Patent Application Publication
(10) Pub. No.: US 2026/0075564 A1
(43) Pub. Date: Mar. 12, 2026

(54) METHODS, ARCHITECTURES, APPARATUSES AND SYSTEMS FOR USING REFERENCE SIGNAL PROFILES FOR ENHANCED LOCALIZATION OR SENSING

(71) Applicant: InterDigital Patent Holdings, Inc., Wilmington, DE (US)

(72) Inventors: Javier Lorca Hernando, Madrid (ES); Alain Mourad, Ascot (GB); Mohammad Heggo, Lewisham (GB); Arman Shojaeifard, London (GB); Yasser Mestrah, Uxbridge (GB); Ibrahim Hemadeh, Hemel Hempstead (GB)

(21) Appl. No.: 18/827,123

(22) Filed: Sep. 6, 2024

(51) Int. Cl. H04W 64/00; H04L 5/00; H04W 8/22

(52) U.S. Cl. CPC H04W 64/00; H04L 5/0012; H04L 5/0051; H04W 8/22

(57) ABSTRACT

Methods and systems are provided for a wireless transmit/receive unit (WTRU). A WTRU sends a capabilities message to a wireless network, receives configuration information for a localization or sensing task, wherein the configuration information comprises a reference signal (RS) reporting trigger, performs a first localization or sensing measurement of a first received RS based on the configuration information, determines whether the RS reporting trigger is satisfied based on the first measurement, reports, based on the RS reporting trigger being satisfied, one or more preferred characteristics of a second RS based on the first localization or sensing measurement to the network, receives an indication to perform a second localization or sensing measurement of a second received RS and performs a second localization or sensing measurement of the second received RS, reports the second localization or sensing measurement and an uncertainty value associated with the second localization or sensing measurement.

### BACKGROUND

The present disclosure is generally directed to the fields of communications, software and encoding, including, for example, to methods, architectures, apparatuses, systems related to using reference signal profiles for localization or sensing.

### SUMMARY

This disclosure relates to selecting and reporting Reference Signal (RS) profiles in localization or sensing. In accordance with the disclosure, accuracy in localization or sensing may be improved by utilizing task and context specific RS profiles based on an RS measurements.

In certain representative embodiments, a method performed by a wireless transmit and/or receive unit (WTRU) is provided. The method may comprise sending a capabilities message to a wireless network. The method may comprise receiving, from the wireless network, configuration information for a localization or sensing task, wherein the configuration information comprises a reference signal (RS) reporting trigger. The method may comprise performing a first localization or sensing measurement of a first received RS based on the configuration information. The method may comprise determining whether the RS reporting trigger is satisfied based on the first localization or sensing measurement. The method may comprise reporting, based on the RS reporting trigger being satisfied, one or more preferred characteristics of a second RS based on the first localization or sensing measurement to the wireless network. The method may comprise receiving, from the wireless network, an indication to perform a second localization or sensing measurement of a second received RS. The method may comprise performing a second localization or sensing measurement of the second received RS; and reporting, to the wireless network, the second localization or sensing measurement and an uncertainty value associated with the second localization or sensing measurement.

In some implementations, the second received RS may comprise the one or more preferred characteristics.

In some implementations, the capabilities message may comprise information indicative of at least one of a supported power profile for an RS or a supported frequency-hopping pattern for an RS.

In certain representative embodiments, a method performed by a wireless transmit and/or receive unit (WTRU) is provided. The method may comprise sending a capabilities message to a wireless network. The method may comprise receiving, from the wireless network, configuration information for a localization or sensing task, wherein the configuration information comprises an Uplink Reference Signal (UL RS) profile. The method may comprise transmitting, to the wireless network, a Reference Signal (RS) based on the configuration information. The method may comprise terminating the transmission of the RS using the UL RS profile based on a termination indication.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a flowchart for reporting of RS profiles for localization and sensing in DL according to one or more embodiments;

FIG. 3 illustrates a flowchart for transmission of RS profiles for localization and sensing in UL according to one or more embodiments;

FIG. 4 illustrates an RS structure based on an RS profile according to one or more embodiments;

FIG. 5 illustrates a structure of an RS profile showing a frequency-hopping pattern according to one or more embodiments;

FIG. 6 illustrates a structure of a RS with RS profile tailored for NLOS channel conditions according to one or more embodiments;

FIG. 7 illustrates a report containing characteristics of a preferred DL RS Profile according to one or more embodiments;

FIG. 8 illustrates a configuration for transmission of UL RS Profiles according to one or more embodiments; and

FIG. 9 illustrates a method for selecting and reporting RS profiles in localization or sensing according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

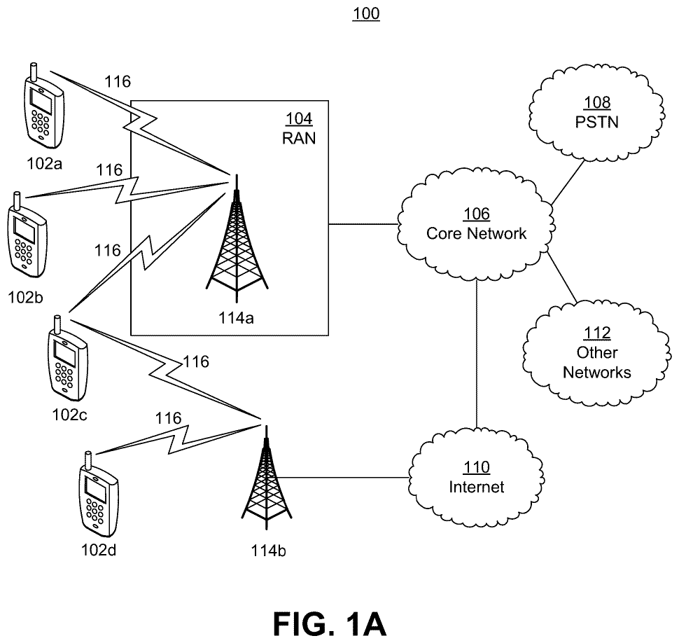

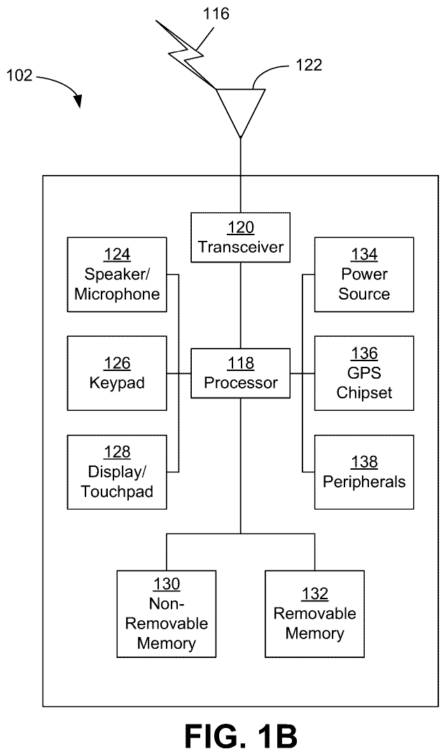

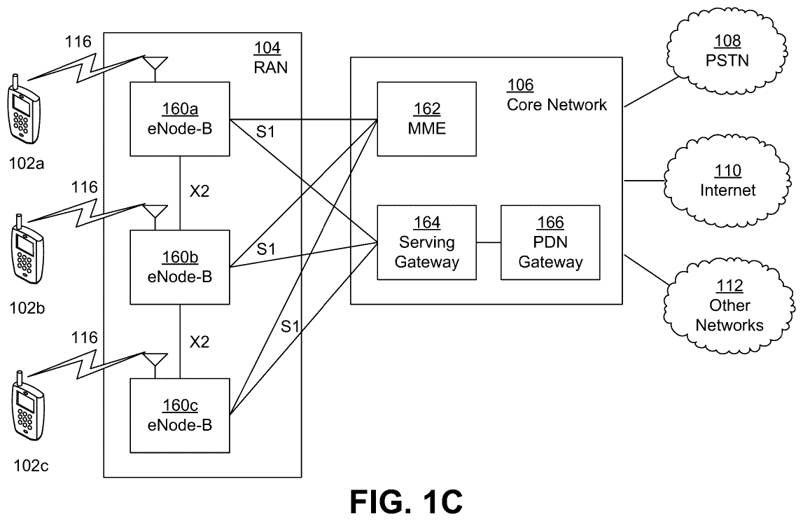

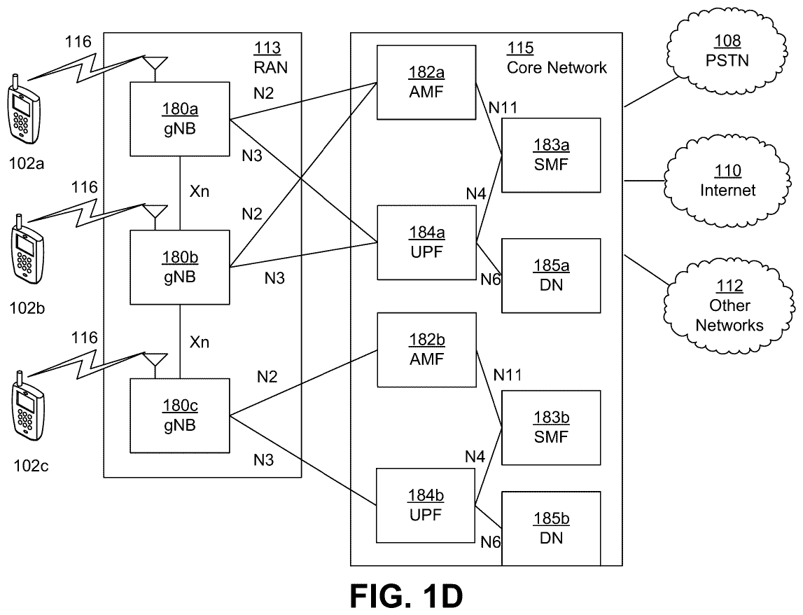

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In certain representative embodiments, methods and procedures for selecting and reporting RS configurations for localization and sensing to optimize accuracy based on a target error metric and a target object are provided.

In certain representative embodiments, without loss of generality, sensing hereinafter may refer to the estimation of one or more spatial characteristics, like, e.g., the absolute or relative position, 3D orientation, speed, etc. of one or multiple objects that may not be connected to the system under consideration. In some wireless systems, sensing may be considered a usage scenario, e.g., when considering integrated sensing and communications (ISAC).

In certain representative embodiments, there may be at least three sensing modes that may be established depending on the relative positions of the transmitter and the receiver, or receivers, with respect to the target sensing object to be sensed:
Monostatic sensing may refer to a scenario where the transmitter and receiver entities are co-located for estimation of one or more of an object's position, velocity, and orientation. Monostatic sensing may be performed by a base station (BS) (also called transmit-receive point, TRP) or a WTRU/user equipment (UE). Sensing may be applied to detect one or multiple objects.

Bistatic sensing may refer to a scenario where the transmitter and receiver entities are not co-located for sensing, with, e.g., a Transmit-Receive Point (TRP) acting as transmitter and a WTRU as receiver, or vice versa.

Multistatic sensing may refer to a scenario where multiple receiving entities aim to sense one or multiple objects with the aid of a transmitting entity that is not co-located with them.

In certain representative embodiments, methods and procedures described hereinafter may generally refer to localization and to any of the monostatic, bistatic and multistatic sensing cases.

In certain representative embodiments, tracking of a moving active/passive object may be likely to follow upon previously performed tasks around localization, sensing, and even communications. These previous tasks may provide a-priori information that may be useful when executing the tracking task next. In certain representative embodiments, the accuracy required for tracking (e.g., in radar locking) may be higher than in non-tracking tasks (e.g., monitoring), as the former may involve intensive scanning of a single target. An example of a tracking task here would be to follow finer movement of an object (e.g. Unmanned Aerial Vehicles (UAV)) with high precision.

In certain representative embodiments, the Reference signal (RS) configuration used in localization or sensing may impact the achievable accuracy. For example, not all subcarriers in an RS configuration may provide the same localization/ranging accuracy. The subcarriers at the edges of the system BW may yield a better estimation accuracy than those at the frequency carrier's center, because the Cramer-Rao Lower Bound (CRLB) of any statistical estimator in localization or sensing may be inversely proportional to the frequency.

In certain representative embodiments, localization may involve some form of beam scanning procedure by the transmitter entity, where positioning beams are generated to cover an area in the environment, e.g., following a sequential order, where WTRUs are expected to perform localization measurements according to a request from a localization service. Localization may involve one or multiple localization transmitters to perform triangulation, multilateration, or other techniques at the localization receiver based on the presence of multiple signals.

In certain representative embodiments, sensing may involve some form of beam scanning procedure by the transmitter entity, where sweeping beams are generated to cover the targeted sensing area in the environment, e.g., following a sequential order, and their reflections are captured by the receiver. In other words, a measurement entity, e.g., a WTRU, must detect one or multiple signal copies reflected by the environment from one or multiple sensing beams, and perform measurements, e.g., of delay, power, angle of arrival (AoA), etc. to differentiate the scatterers from the eventual clutter produced by undesired sources.

In certain representative embodiments, tracking a moving WTRU or target may involve a dedicated beam following the object's movement. Past knowledge of the WTRU's or the target's location and speed may be useful in improving the accuracy of the localization and sensing tasks.

In certain representative embodiments, without limiting the descriptions herein, one or more TRPs and one or more WTRUs may be provided, both acting as transmitting or receiving entities for localization/sensing depending on the service needs. Downlink (DL) localization or sensing may involve a WTRU receiving signals from one or more transmitting TRPs, performing localization or sensing measurements, and reporting them to the network. Uplink (UL) localization or sensing may involve one or more TRPs receiving signals from one or more transmitting WTRUs and performing the necessary tasks to locate the WTRU or the target to be sensed.

In certain representative embodiments, whether for initial localization/sensing of a target or WTRU, or for tracking its movement, in some cases the accuracy in the determination of its location and/or speed may need to be improved, e.g., to fulfil specific service requirements or to overcome harsh channel conditions that lead to insufficient accuracy.

In certain representative embodiments, insufficient accuracy in localization may arise in low SNR conditions or in the presence of NLOS links without direct visibility between the transmitter and the receiver. Similarly, insufficient accuracy in sensing may arise in low SNR conditions or in the presence of NLOS links, without direct visibility between the sensing transmitter and the target or between the target and the sensing receiver.

In certain representative embodiments, increasing the accuracy for a given RS configuration with uniform power profile requires improving the SNR, the bandwidth, or both. An increase in the SNR and/or the bandwidth of a RS transmission may not always be feasible. This may be due to the RS bandwidth in some cases being determined by semi-static system parameters that may not allow for changes in the timescale required by the task, or due to unpredictable channel variations affecting the SNR.

In certain representative embodiments, the central subcarriers in a RS configuration may not yield the same accuracy compared to the subcarriers at the edges, and allocating power on these subcarriers may degrade the localization accuracy. If the accuracy needs to be higher, the RS configuration may not be optimal to execute the task if all the RS subcarriers are treated equally. The RS transmission may therefore need to reinforce (e.g. by allocating more power) the edge subcarriers to suit best the requirements of the tracking task, also accounting for the availability of the a-priori information from the previous tasks.

In certain representative embodiments, parameters that are used to tune/adjust to come up with an RS configuration such that the higher accuracy of the edge subcarriers is exploited is provided, and the sensing target/user channel conditions (e.g. Line of sigh (LOS) or Non-line of sight (NLOS)) are taken into account.

In certain representative embodiments, methods to select and report RS profiles in localization or sensing to improve accuracy of detection are provided such that the higher accuracy of the edge subcarriers may be exploited and the target/WTRU channel conditions (including the presence of LOS and NLOS conditions) are taken into account, while leveraging the a-priori information from previous localization or sensing tasks to better fine tune the RS configuration. In certain representative embodiments, both DL reception and UL transmission of RS profiles by the WTRU may be provided.

In certain representative embodiments, a WTRU capable of receiving DL reference signals for localization or sensing may perform at least one of: receive configuration information that configure the WTRU to perform localization and/or sensing measurements on a first RS and a second RS, the latter based on DL RS profiles able to achieve a higher accuracy and characterized by a “U” shape, non-uniform power profile, and frequency-hopping pattern; perform localization and/or sensing measurements on a first RS and check the conditions for reporting enhanced DL RS profiles; If fulfilled, the WTRU may report the characteristics of a second RS containing one or more preferred configurations for DL RS profiles, each characterized by their RS resources, RS shape, power profile, frequency-hopping pattern, main lobe's accuracy, and sidelobe ambiguity, based on the target Mean Square Error (MSE), LOS/NLOS conditions, and channel state information; receive an indication from the network to perform measurements on a second RS characterized by DL RS profile and reports their results and the associated uncertainties to the network; check if DL RS profiles are outdated based on DL RS profiles update conditions and, in such case, may send a report to the network containing updated DL RS profiles; terminate measurements on a second RS based on DL RS profiles termination conditions and may send a control signaling indication to the network.

In certain representative embodiments, a WTRU capable of transmitting UL RS for localization or sensing may perform at least one of: receive a configuration message from the network containing the transmission characteristics of a RS using UL RS profiles, including RS resources, RS shape, power profile, and frequency-hopping pattern; transmit to the network a RS for localization or sensing according to the configured UL RS resources and RS profile; terminate the transmission of a RS using UL RS profiles based on a termination indication received from the network, or after a pre-defined time interval, number of transmissions, transmission pattern, etc. previously configured by the network.

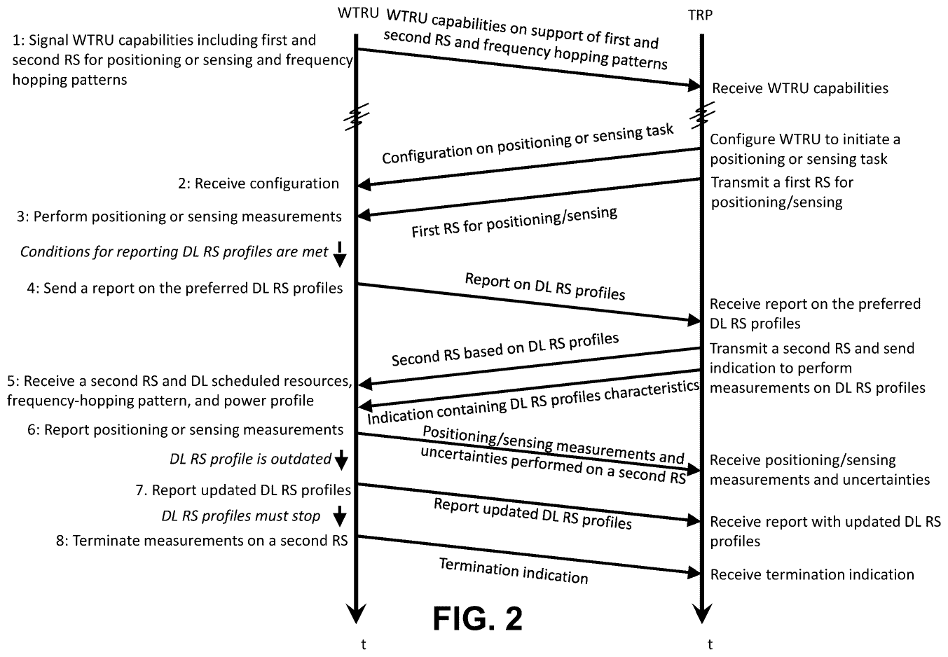

FIG. 2 illustrates a flowchart of WTRU and TRP actions for reporting of RS profiles for localization and sensing in DL according to one or more embodiments. The WTRU actions may be performed by any of the WTRUs 102 of FIGS. 1A-D and the TRP actions may be performed by any of the base stations 114 of FIG. 1A, the eNode-Bs 160 of FIG. 1C, or the gNBs 180 of FIG. 1D.

In certain representative embodiments, as illustrated in FIG. 2, a WTRU capable of receiving DL reference signals for localization or sensing purposes may perform one or more actions provided in the following paragraphs:
The WTRU may send a capabilities message to the network (e.g., after random access or upon network request) on the support of a localization or sensing task including one or more RS types for localization or sensing measurements, power profiles, and frequency hopping patterns, wherein the power profiles and frequency hopping patterns characterizing the DL RS profiles are pre-determined and known to the WTRU (e.g., stored in its default configuration/capabilities list);

The WTRU may be configured by the network to initiate a localization or sensing task. The WTRU may receive a configuration information including one or more information provided in the following paragraphs:
Type of localization/sensing task, e.g., ‘RS measurements for localization’, ‘RS measurements for sensing’, ‘RS measurements for tracking’, etc.;
Available resources for a first and a second RS (Bandwidth (BW), no. symbols, periodicity, Transmission Configuration Indication (TCI) states, antenna ports, time window, values of N and M);
A minimum threshold of any of the Signal to Noise Ratio (SNR), Reference Signal Received Power (RSRPP), accuracy, etc. for a Channel Impulse Response (CIR) peak to be considered by the WTRU in the localization or sensing task;
An indication to perform sensing measurements on a given sensing area (e.g., as determined by a range of SNR, RSRPP, etc. values), or on one or more multipath components, specified by any of their Multipath Component (MPC) number, Time of Arrival (ToA), Angle of Arrival (AoA), SNR, RSRPP, etc. over a configured or pre-determined time window;
Assistance information for the localization or sensing task (sensing beam spatial relationships, localization information, measurements to perform, etc.);
One or more available power profiles of the second RS (each given as an index in a discrete set, a pre-defined field, e.g., ‘uniform’/‘non-uniform’, a bitmap of power levels per sub-band or per group of subcarriers, etc.);
One or more available frequency-hopping patterns of the second RS (each given as an index in a pre-defined set of patterns, a list of values of M and D, etc.);
A threshold T for the minimum likelihood of LOS (in localization) or single-bounce conditions (in sensing);
Triggers for reporting DL RS profiles, as one or more of: A Doppler or velocity range of any of the WTRU or sensed targets; Uncertainty in one or more of the sensing metrics (e.g., ToA, AoA, SNR, RSRPP, RSCP, etc.) above a threshold T1 or set of thresholds per each sensing metric; A MSE of any of the position or velocity of the WTRU or sensed targets above a threshold T2; An SNR or RSRPP threshold T3 for the one or more LOS/MPC components corresponding to any of the WRTU or sensed targets; An explicit indication to report DL RS profiles for one or more multipath components, specified by any of their MPC number, ToA, AoA, SNR, RSRPP, etc. over a configured or pre-determined time window;
Triggers for updating the reporting on DL RS profiles, as one or more of: A change in the uncertainty in any of the sensing metrics above a threshold; A change in the MSE of any of the position or velocity of the WTRU or sensed targets above a threshold; A change in any of the SNR, RSRPP, or LOS/NLOS likelihood for the one or more LOS/MPC components corresponding to any of the WTRU or sensed targets above a threshold; A change in the position or the velocity of any of the WTRU or the targets above a threshold; A time elapsed since the last reporting of DL RS profiles information exceeding an absolute or relative duration, e.g., a configured periodicity; A WTRU re-configuration message containing updated configuration parameters for reporting of DL RS profiles; A change in the detected RS resources of a second RS, e.g., the birth or death of one or more RS at their configured time-frequency locations, or the corresponding antenna ports; A network request;
Triggers for termination of the use of any DL RS profile and fallback to a first RS, as one or more of: A Doppler or velocity of any of the WTRU or sensed targets outside a range, e.g., a min and a max value; Uncertainty in one or more of the sensing metrics (e.g., ToA, AoA, SNR, RSRPP, Reference Signal Carrier Phase (RSCP), etc.) below a threshold T4 or set of thresholds per each sensing metric; A MSE of any of the position or velocity of any of the WTRU or sensed targets below a threshold T5; An SNR or RSRPP above a threshold T6 for the one or more LOS/MPC components corresponding to any if the WTRU or sensed targets; A network request containing an indication from the network to fallback to a first RS whose resources are, e.g., determined by the configuration, or explicitly indicated by their BW, no. symbols, periodicity, TCI states, antenna ports, etc.; A time elapsed since the last reporting of DL RS profiles information exceeding a maximum absolute or relative duration. A low-battery indication by the WTRU.

The WTRU may receive a first RS for localization or sensing and may perform the configured measurements, e.g., in the allocated measurement time window indicated to the WTRU;

The WTRU may report to the network the preferred characteristics of a second RS using DL RS profiles (via Uplink Control Indicator (UCI) signalling, Medium Access Control-Control Element (MAC CE), Radio Resource Control (RRC), etc.) based on the conditions for reporting DL RS profiles, containing one or more of: Estimated Doppler/velocity of the WTRU or sensed object (Hz, m/s, etc.); SNR or RSRPP of the LOS/MPC components being measured; Channel's coherence bandwidth, e.g., expressed in Hz, number of RB, an index in a table, etc.; and One or more recommended RS profiles for the second RS, each expressed as one or more of: Number of symbols and periodicity, Recommended power profile, Recommended values of N and M, wherein N is the number of subcarriers in the upper and lower part of the RS profile and M is the separation in subcarriers between the upper and lower part, wherein N is based on the measured SNR and the target MSE, e.g., obtained from the CRLB of the estimation variance, wherein N is upper bounded by the channel's coherence bandwidth based on the likelihood of LOS or single-bounce conditions below T, Recommended frequency-hopping pattern, e.g., as an index, a list of values of M and D, etc., Estimated main lobe's accuracy, e.g., the MSE of the ranging profile's main lobe (m, %) based on the SNR or RSRPP of the LOS/MPC component, Estimated sidelobe ambiguity, e.g., as the relative sidelobe level with respect to the main lobe in the ranging profile (dB, natural units, % . . . ) based on the SNR or RSRPP of the LOS/MPC component;

The WTRU may receive from the network an indication to perform localization/sensing measurements on a second RS based on DL RS profiles (via Downlink Control Indicator (DCI) signalling, MAC CE, RRC, etc.), containing one or more of: DL scheduled resources for the second RS (N, M, number of symbols, periodicity, TCI states, etc.); One or more allocated frequency-hopping patterns; One or more power profiles;

The WTRU may report to the network the localization or sensing measurements, and their uncertainties, as performed on the DL scheduled resources of the second RS;

The WTRU may determine if the RS profiles are outdated based on the conditions for update of DL RS profiles and, in such case, sends a report to the network (via Uplink Control Indicator (UCI) signalling, MAC CE, RRC, etc.) containing one or more of: Updated value of the estimated Doppler/velocity of any of the WTRU or sensed targets; Updated value of the SNR or RSRPP of any of the LOS/MPC components being measured; and Updated value of the channel's coherence bandwidth; One or more updated DL RS profiles for the second RS;

The WTRU may terminate the measurements on a second RS using DL RS profiles based on the conditions for termination of DL RS profiles, and, when not triggered by the network, may send a control signaling to the network containing a termination indication.

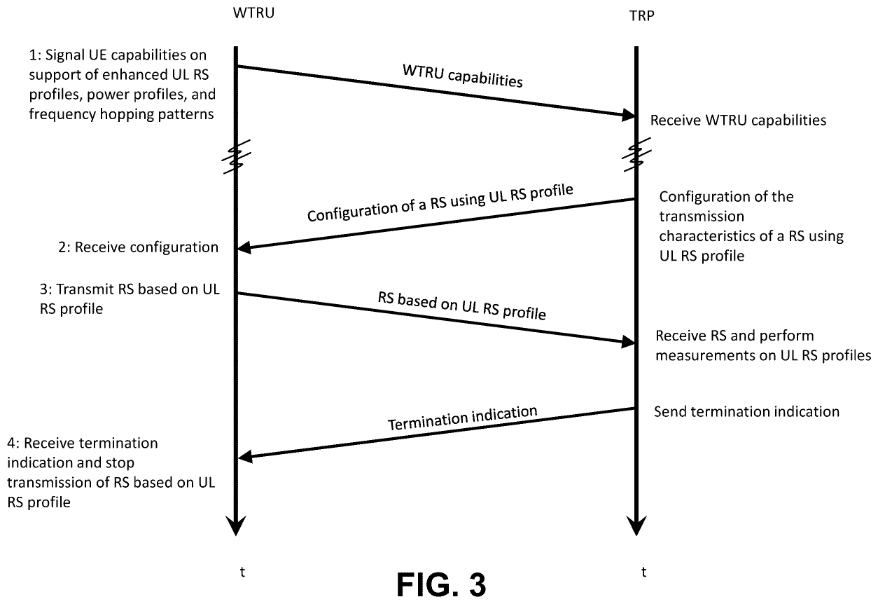

FIG. 3 illustrates a flowchart of WTRU and TRP actions for transmission of RS profiles for localization and sensing in UL according to one or more embodiments. The WTRU actions may be performed by any of the WTRUs 102 of FIGS. 1A-D and the TRP actions may be performed by any of the base stations 114 of FIG. 1A, the eNode-Bs 160 of FIG. 1C, or the gNBs 180 of FIG. 1D.

In certain representative embodiments, as illustrated in FIG. 3, a WTRU capable of transmitting UL reference signals for localization or sensing purposes may perform one or more actions provided in the following paragraphs:
The WTRU may send a capabilities message to the network (e.g., after random access or upon network request) on the support in transmission of a RS for localization or sensing, UL RS profiles, frequency hopping patterns, and power profiles, wherein the power profiles and frequency hopping patterns characterizing the RS profiles are pre-determined and known to the WTRU (e.g., stored in its default configuration/capabilities list);
The WTRU may receive from the network a configuration message (via DCI signalling, MAC CE, RRC, etc.) containing the transmission characteristics of a RS using UL RS profiles, containing one or more of the following information: Type of localization/sensing task, e.g., ‘localization RS transmission’, ‘sensing RS transmission’, etc.; UL RS scheduled resources using UL RS profiles (BW, no. symbols, periodicity, TCI states, antenna ports, etc.); UL RS profile characteristics, including one or more of: Number of symbols to allocate and periodicity. Selected power profile of the RS (given as an index in a discrete set, a pre-defined field, e.g., ‘uniform’/‘non-uniform’, a bitmap of power levels per sub-band or per group of subcarriers, etc.). Values of N and M. Allocated frequency-hopping pattern (given as an index in a pre-defined set of patterns, a list of values of M and D, etc.);
The WTRU may transmit to the network a RS for localization or sensing according to the configured UL RS profile, scheduled resources, allocated frequency-hopping pattern, and selected power profile;

The WTRU may terminate the transmission of a RS using UL RS profiles based on a termination indication received from the network (via DCI signalling, MAC CE, RRC, etc.), or after a pre-defined time interval, number of transmissions, transmission pattern, etc. previously configured by the network.

Throughout this disclosure, a “UE”, “localization receiver”, “sensing receiver” and “WTRU” may be used interchangeably to refer to any entity receiving localization or sensing signals.

Throughout this disclosure, a “localization transmitter” or “sensing transmitter” may refer to any entity transmitting localization or sensing signals. It may be used interchangeably with “TRP”, “gNB” and/or “BS” in a non-limiting way.

Throughout this disclosure, the terms “object”, “target”, “target object” and “sensing target” may be used interchangeably to refer to an object whose characteristics are intended to be sensed that is not wirelessly connected to the system under consideration.

Throughout this disclosure, the term “single-bounce conditions” may be used to refer to a reflection caused by an object that reaches the sensing receiver with direct visibility, i.e., without additional reflections.

Throughout this disclosure, the term “multiple-bounce conditions” may be used to refer to a reflection caused by an object that reaches the sensing receiver without direct visibility, i.e., after experiencing additional reflections with other objects.

Throughout this disclosure, the terms “DL RS profile”, “UL RS profile” and “RS profile” may be used to refer to a RS structure with a “U” shape comprising subcarrier allocations only in the upper and lower parts of a frequency region with a non-uniform power profile.

Throughout this disclosure, the symbol “N” can be used to refer to the number of subcarriers of the upper and lower parts of a RS allocation with a “U” shape in an RS profile.

Throughout this disclosure, the symbol “M” can be used to refer to the number of subcarriers between the upper and lower parts of a RS allocation with a “U” shape.

Throughout this disclosure, the symbol “D” can be used to refer to the offset, in number of subcarriers, between the beginning of the allocated bandwidth for localization/sensing and the upper part of a RS allocation with a “U” shape.

Throughout this disclosure, the term “power profile” can be used to refer to the power variations of a RS in the frequency domain, e.g., as a function of the subcarrier index.

Throughout this disclosure, the term “localization” can be used to refer to obtaining suitable coordinates for the location of a WTRU or target object, either or not relative to a local area/map.

In certain representative embodiments, a cellular scenario is provided where a measurement entity or sensing receiver (e.g., UE, WTRU) is tasked to sense the environment by performing sensing measurements to derive spatial information about the surrounding objects, e.g., their location, speed, orientation, etc. as determined by the system or the application. In certain representative embodiments, in a bistatic sensing scenario a sensing transmitter may send reference signals that are captured by a sensing receiver with the goal of determining the location and characteristics of one or more targets in the environment, e.g., their position, orientation, velocity, object type (e.g., ‘pedestrian’, ‘car’, etc.), object dimension, object materials, etc. The sensing receiver may also be impacted by reflections or diffractions from clutter (e.g., the ground, a tree, etc.) and from other objects (non-target related) existing in the same environment as the target object(s). A multistatic sensing scenario comprises multiple sensing receivers whose sensing measurements are collected by the network.

In certain representative embodiments, a sensing transmitter (e.g., a TRP) may comprise any number of transmit-receive antennas, e.g., in a Massive Multiple Input-Multiple Output (M-MIMO) configuration, with up to N antenna ports for the transmission of sensing signals. WTRUs may be equipped with one or multiple receive antennas.

In certain representative embodiments, without loss of generality, a suitable RS may already exist for sensing measurements, either in the form of an existing signal that is re-purposed for sensing, like, e.g., the DL Positioning Reference Signal (PRS) or the UL Sounding Reference Signal for Positioning (SRSp) in 5G NR, or a dedicated sensing reference signal. This signal may be referred to as a first RS for localization/sensing. Similarly, a suitable RS may already exist for CSI acquisition, like, e.g., CSI-RS, SSB, or any other physical signal.

Throughout this disclosure, descriptions are applicable to any waveform comprising discrete samples that can be analysed by suitable subcarriers in the frequency domain, via, e.g., application of Discrete Fourier Transforms (DFT), like CP-OFDM, DFT-s-OFDM, CE-OFDM, SC-FDE, etc., and not precluding other waveforms.

### RS Profiles

In certain representative embodiments, an RS structure with a “U” shape may improve the localization/sensing accuracy, i.e., can present a lower MSE of detection. Such shape which can be viewed as a new type of RS is hereby denoted as an RS profile, either in UL or DL.

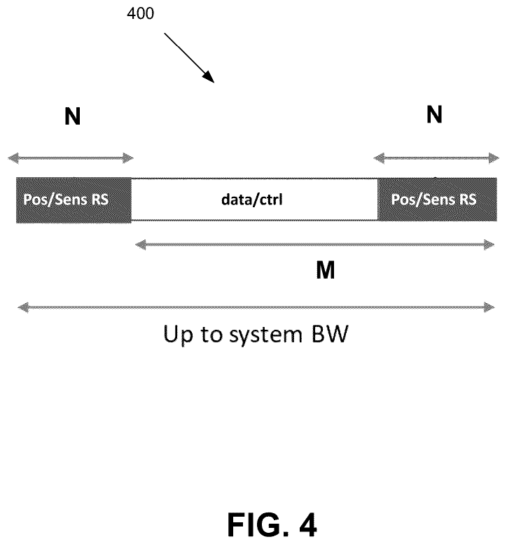

FIG. 4 illustrates a structure 400 of an RS based on an RS profile according to one or more embodiments. The RS structure 400 may comprise two subcarrier allocations N having a non-uniform power profile separated by M subcarriers.

In certain representative embodiments, RS profiles may be described by two symmetrical allocations in frequency, each comprising N contiguous subcarriers separated by M subcarriers with a certain power profile as illustrated in FIG. 4.

In certain representative embodiments, MSE in localization or sensing may be measured as the uncertainty of the ranging profile at the main lobe, or main lobe's accuracy. Some “U”-shaped RS profiles may have better MSE of localization/sensing, at the cost of a higher sidelobe level, i.e., a higher ratio of sidelobe's power vs. main lobe's power. In certain representative embodiments, non-uniform power profiles may have a better MSE in localization/sensing despite the higher CRLB that results from the comparatively lower bandwidth, because the ranging profile can have a narrower main lobe at the cost of a higher sidelobe level.

In certain representative embodiments, the sidelobe level may impact the ambiguity in resolving the WTRU or target position because, when obtaining the channel impulse response, thermal noise may cause a sidelobe to appear with a higher power level than the central lobe, thus leading to an error in the target's location when detecting the highest peak. However, if there is any additional contextual information about the WTRU or the target (e.g., from a past measurement, or knowledge of an approximate location or velocity, etc.) then the secondary lobes may be discarded and not cause any harm to the localization or sensing process.

In certain representative embodiments, the ambiguity corresponding to a given RS profile may be estimated and reported to the network by the WTRU. This information may be useful e.g., to schedule periodic measurements for a tracking task in localization or sensing. In such case, mobility of the WTRU or the target may not lead to a change in the position between consecutive measurements that is higher than the estimated ambiguity. In certain representative embodiments, if the velocity of the WTRU or target is known (from past measurements or other side information), an RS profile can be selected whose corresponding ambiguity is higher than the distance expected to be traversed between two consecutive measurements, in such a way that ambiguity of detection may be avoided at the receiver.

### Frequency-Hopping Pattern

In certain representative embodiments, a frequency-hopping pattern may minimize the impact of any channel's deep fades that may occur in the subcarriers allocated for the active N parts as illustrated in FIG. 4. This may come at the cost of a smaller bandwidth, since M can no longer be equal to the system bandwidth to give the chance for RS transmissions to switch between different hopping patterns, e.g., at rotating frequency positions.

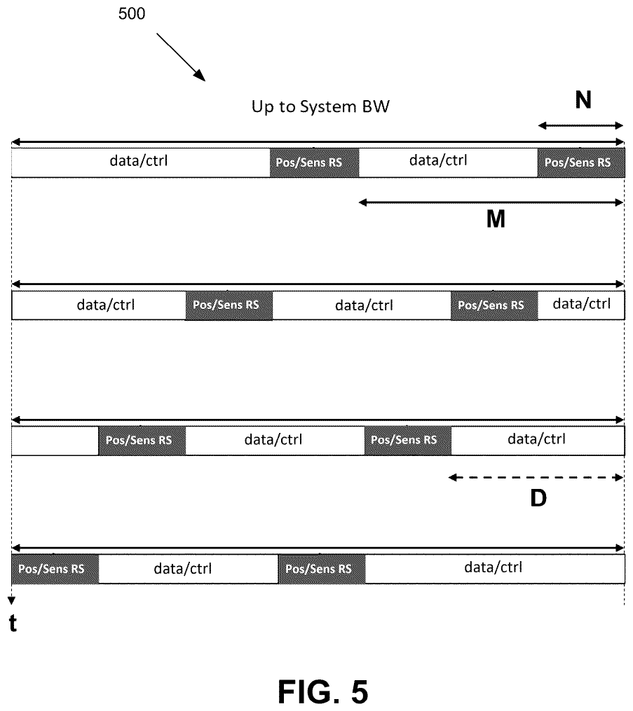

FIG. 5 illustrates a structure 500 of an RS profile showing a frequency-hopping pattern according to one or more embodiments. In certain representative embodiments, as illustrated in FIG. 5, a parameter D may account for the dynamic offset in the RS allocation that can change with every RS transmission.

### RS Profiles for NLOS Conditions

In certain representative embodiments, in NLOS conditions, N may be lower or equal to the channel's coherence BW to minimize resources consumption and enable velocity estimation when in flat channel conditions.

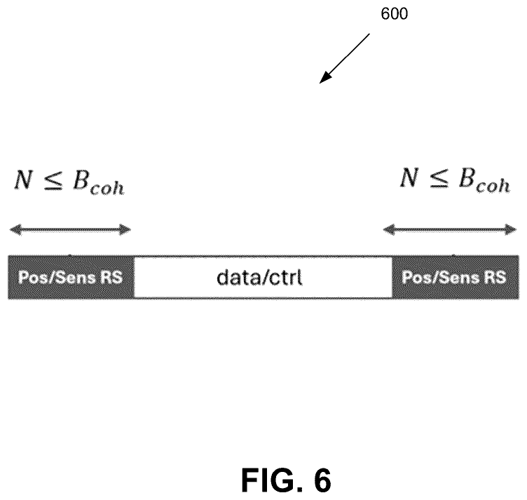

FIG. 6 illustrates structure 600 of a RS with RS profile tailored for NLOS channel conditions according to one or more embodiments. The selection of N may be based on the LOS/NLOS channel conditions in addition to the channel state information and target MSE of localization/sensing.

In certain representative embodiments, methods are provided to facilitate performing sensing tasks based on: Better accuracy in the location estimation when performing a localization or sensing task; Better exploitation of past known positions in tracking. Better latency and power saving from the lower number of symbols needed to achieve the required accuracy in localization/sensing; More robust localization and sensing because of a better adaptation of the RS to the channel conditions to meet a target MSE; More robust localization and sensing because of a better adaptation of the RS in NLOS conditions to minimize resources and enable velocity estimation.

### Reporting of RS Profiles for Localization and Sensing in DL

In certain representative embodiments, methods and procedures for the reporting of RS profiles for localization and sensing in DL by the WTRU are provided.

### WTRU Capabilities

In certain representative embodiments, the WTRU may receive and decode a first network request, e.g., received through RRC signalling, to provide capabilities information related to the support of DL RS profiles for localization and sensing.

In certain representative embodiments, the WTRU may receive and decode this first network request following the random-access procedure.

In certain representative embodiments, the WTRU may prepare a capabilities information message including information related to the support of DL RS profiles for localization and sensing.

In certain representative embodiments, the information contained in the WTRU capabilities message may include one or more of the following: support of a first RS for localization or sensing measurements; support of a second RS for localization or sensing measurements characterized by DL RS profiles, wherein the DL RS profiles are pre-determined and known to the WTRU (e.g., stored in its default configuration/capabilities list); supported power profiles for a second RS; supported frequency-hopping patterns for a second RS; sensing processing capabilities (e.g., inverse frequency transform capabilities, maximum number of samples, etc.); sensing frequency ranges; sensing bandwidth; sensing modes (e.g., monostatic, bistatic, etc.); sensing priorities; sensing spatial resolution; support of ToA or TDoA determination and related time resolution; support of AoA determination and related AoA resolution; support of RCS determination; support of RSRPP determination and related power resolution; support of carrier phase measurements and related phase resolution; sensing doppler resolution; reflectivity sensitivity, this may include one or more of a minimum power, SNR, absolute amplitude, etc. for reflections to be detectable by the WTRU.

In certain representative embodiments, the WTRU may send the WTRU capability information message (i.e. capabilities message) through RRC signalling, e.g., over PUSCH.

In certain representative embodiments, the WTRU capabilities information may be used by the network to optimize its configuration and allocation of DL RS profiles for localization or sensing.

### UE Configuration

In certain representative embodiments, the WTRU may receive configuration information. The WTRU may be configured by the network to initiate a localization or sensing task by means of one or more of the following information received, e.g., from a control or data channel via RRC configuration, DCI information, MAC CE signaling, etc., the configuration information may include one or more of:
Type of localization/sensing task to conduct by the WTRU according to the service configuration, e.g., ‘RS measurements for localization’, ‘RS measurements for sensing’, ‘RS measurements for tracking’, etc.;
Information about the localization or sensing RS resources for CIR estimation for a first and a second RS (e.g., CSI-RS, PRS, etc.), e.g., time/frequency allocation, bandwidth, symbol and comb offsets, periodicity, TCI states, antenna ports, time window, etc. and including the values of N and M that characterize the second RS;
A minimum threshold of any of the SNR, RSRPP, accuracy (e.g., as an inverse of MSE), correlation with the transmitted signal, etc. for a CIR peak to be considered by the WTRU in the localization or sensing task;
An indication to perform sensing measurements on a given sensing area (e.g., determined by a range of SNR, RSRPP, etc. values), or on one or more multipath components, specified by any of their MPC number, ToA, AoA, SNR, RSRPP, etc. over a configured or pre-determined time window;
Assistance information to perform inverse frequency transformations for obtaining CIR responses, e.g., frequency range, bandwidth, frequency layer identifier (e.g., PFL-ID), bandwidth part (e.g., BWP-ID), number of FFT samples, etc.;
Spatial relationships between antenna ports for sensing, including information about the antenna ports that are co-located in a same TRP and beam, e.g., in the form of configured TCI states with associated QCL characteristics;
Localization information, e.g., expressed as the ToA of the LOS component for each sensing TRP, AoAs, coordinates of UE and sensing TRPs, 3D orientation of UE and TRP, LOS likelihoods, etc.;
Measurements to perform, e.g., ToA, TDoA, AoA, absolute or relative RSRPP, RSCP, doppler spectrum, RCS, etc.;
One or more available power profiles of the second RS, each given, e.g., as any of: An index in a discrete set; A field, e.g., ‘uniform’/‘non-uniform’; A bitmap of power levels per sub-band or per group of subcarriers, expressed in dB, natural units, etc.;
One or more available frequency-hopping patterns of the second RS (each given as an index in a pre-defined set of patterns, a list of values of M and D, etc.);
A threshold T for the minimum likelihood of LOS (in localization) or single-bounce conditions (in sensing);
Conditions for triggering the reporting of DL RS profiles by the UE, as one or more of: A Doppler or velocity range of any of the WTRU or sensed targets, e.g., a min and a max value; Uncertainty in one or more of the sensing metrics (e.g., ToA, AoA, SNR, RSRPP, RSCP, etc.) of any of the WTRU or sensed targets above a threshold T1 or set of thresholds per each sensing metric; A MSE of any of the position or velocity of the WTRU or sensed targets above a threshold T2; An SNR or RSRPP below a threshold T3 for the one or more LOS/MPC components corresponding to any of the WTRU or sensed targets; An explicit indication to report DL RS profiles for one or more multipath components over a configured or pre-determined time window, each specified by any of: MPC number in the estimated CIR; Absolute or relative ToA (e.g., with respect to another multipath component); AoA (e.g., specified with respect to a known orientation, or given by the rotation angles, Euler angles, etc.); RCS (e.g., in dB or natural units according to a pre-defined format); Threshold RSRPP or SNR;
Conditions for triggering an updated report of DL RS profiles by the WTRU, as one or more of: A change in the uncertainty in any of the sensing metrics above a threshold; A change in the MSE of any of the position or velocity of the UE or sensed targets above a threshold; A change in any of the SNR, RSRPP, or LOS/NLOS likelihood for the one or more LOS/MPC components corresponding to any of the WTRU or sensed targets above a threshold; A change in the position or the velocity of any of the WTRU or the targets above a threshold; A time elapsed since the last reporting of DL RS profiles information exceeding an absolute or relative duration, e.g., a configured periodicity; A WTRU re-configuration message containing updated configuration parameters for reporting of DL RS profiles; A change in the detected RS resources of a second RS, e.g., the birth or death of one or more RS at their configured time-frequency locations, or the corresponding antenna ports; A network request;
Conditions for termination of DL RS profiles, as one or more of: A Doppler or velocity of any of the WTRU or sensed targets outside a range, e.g., a min and a max value; Uncertainty in one or more of the sensing metrics (e.g., ToA, AoA, SNR, RSRPP, RSCP, etc.) of any of the WTRU or sensed targets below a threshold T4 or set of thresholds per each sensing metric; A MSE of any of the position or velocity of any of the WTRU or sensed targets below a threshold T5; An SNR or RSRPP above a threshold T6 for the one or more LOS/MPC components corresponding to any of the WTRU or sensed targets; A network request containing an indication from the network to fallback to a first RS whose resources are, e.g., determined by the configuration, or explicitly indicated by their BW, no. symbols, periodicity, TCI states, antenna ports, etc.; A time elapsed since the last reporting of DL RS profiles information exceeding a maximum absolute or relative duration; A low-battery indication by the WTRU.

In certain representative embodiments, after receiving a network request for termination of DL RS profiles, the resources of a first RS to fallback by the WTRU may be determined by the configuration of the localization or sensing RS resources for CIR estimation. In certain representative embodiments, the resources of a first RS are explicitly indicated as part of the network request, containing, e.g., the BW, no. symbols, periodicity, TCI states, antenna ports, etc.

In certain representative embodiments, the WTRU may receive a re-configuration message from the network containing updated configuration parameters for the localization or sensing task, e.g., from a control or data channel via RRC configuration, DCI information, MAC CE signaling, etc. This message may contain part or all of the above information, and its reception may override part or all of a configuration previously received by the WTRU.

### Measurements for Localization or Sensing

In certain representative embodiments, the WTRU may receive a first RS for localization or sensing per as the configuration, in the form of, e.g., a SSB, CSI-RS, PRS, a dedicated RS for sensing, etc.

In certain representative embodiments, the WTRU may be configured by the network to measure at least one of the ToA, TDoA, AoA, absolute or relative RSRPP, RSCP, doppler spectrum, RCS, etc. with the associated time from the resources. The WTRU may perform the configured measurement in the allocated measurement time window indicated to the WTRU. In certain representative embodiments, the time window configuration may consist of at least one of the following: Start or end time of the window (e.g., in terms of symbol index, slot index, frame index, absolute time, relative time with respect to a reference point); Duration of the window (e.g., in terms of number of symbols, slots, frames, subframes, seconds); Periodicity of the window (e.g., in terms of number of symbols, slots, frames, subframes, seconds).

In certain representative embodiments, the WTRU may receive multiple RSs from one or multiple configured antenna ports for sensing (e.g. from different TRPs and/or single TRP). In that case, the WTRU may perform multiple (pre) configured measurements at the different channel responses obtained from the available TRPs and antenna ports for localization or sensing. To accomplish this, the WTRU may perform at least one of the following actions:
The WTRU may obtain the channel frequency responses at the configured RS resources, e.g., by removing the known values of the RS complex symbols and performing interpolation of the resulting responses over the desired frequency region;
The WTRU may obtain the corresponding time-domain CIR responses, e.g., by performing inverse frequency transformations to the obtained frequency responses, e.g., by means of Inverse Discrete Fourier Transforms; In certain representative embodiments, the WTRU may obtain the PDP responses by computing the absolute square magnitude of the CIR responses;
In certain representative embodiments, the WTRU may obtain the time-domain CIR responses by performing sliding correlations between the received signal and time-shifted versions of the transmitted signal to locate the CIR peaks;
The WTRU may keep those CIR or PDP peaks whose powers or SNRs exceed a minimum configured RSRPP or SNR threshold, or whose peak correlation value between the received signal and the transmitted sensing signal is above a threshold, and discard all others.

In certain representative embodiments, the WTRU may keep the CIR or PDP peaks that are received within a preconfigured ToA or delay window, and discard all the others;

In certain representative embodiments, the WTRU may compare the CIR or PDP responses against a preconfigured CIR or PDP response expressed as a function of time. The WTRU may select the CIR peaks such that the difference between the pdf of the measured CIR or PDP response, and one or more preconfigured CIR or PDP responses, are below a preconfigured threshold.

In certain representative embodiments, the WTRU may be configured to perform the inverse frequency transformation of the channel frequency responses based on its capability. The WTRU may receive at least one of the following assistance information for performing the inverse frequency transformation:
In certain representative embodiments, the network may indicate the RS carrier frequency range where the WTRU may perform the inverse frequency transformation; The network may indicate to the WTRU information in terms of: Start frequency, stop frequency (e.g., in terms of Hz, number of REs, number of RBs, etc.); Frequency offset with respect to an indicated reference frequency (e.g., ARFCN). Signal bandwidth (e.g., in terms of Hz, number of RBs, number of REs, etc.); A frequency layer identifier, e.g., PFL-ID. A subset of the carrier bandwidth to be used for sensing, e.g., a BWP-ID;
In certain representative embodiments, the WTRU may indicate the number of samples for the frequency transformation (e.g., number of samples for inverse-FFT).

### Reporting of DL RS Profiles

In certain representative embodiments, the WTRU may check the conditions for reporting DL RS profiles and, if fulfilled, the WTRU may send to the network a report containing the preferred characteristics of a second RS using DL RS profiles (via UCI signaling, MAC CE, RRC, etc.).

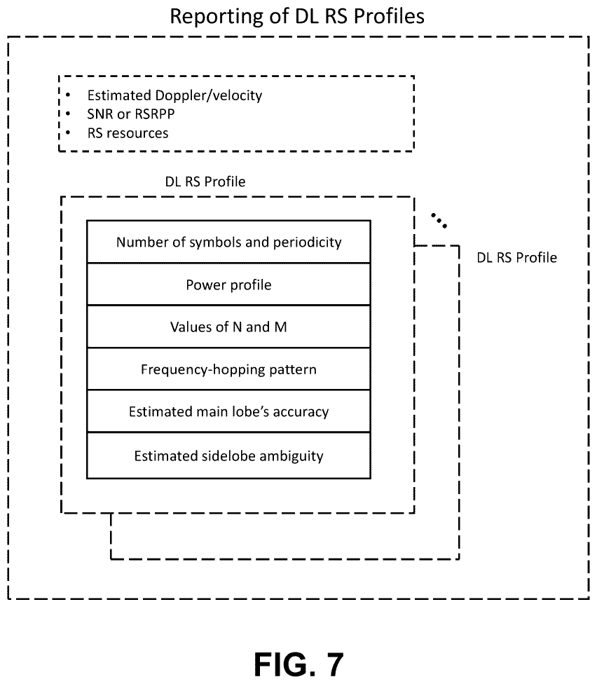

FIG. 7 illustrates contents of a report containing the characteristics of the preferred DL RS Profiles by the WTRU according to one or more embodiments.

In certain representative embodiments, the report from the WTRU may contain one or more of the following information, as illustrated in FIG. 7:
Estimated Doppler/velocity of the WTRU or sensed object (in Hz, m/s, etc.);
SNR or RSRPP of the LOS/MPC components being measured. Measurements may be averaged over a specified or pre-determined time window, e.g., given as a start and end time (in terms of symbol index, slot index, frame index, absolute time, relative time with respect to a reference point, etc.), or a duration with respect to a given time instant (in number of symbols, slots, frames, subframes, seconds, etc.);
Channel's coherence bandwidth, e.g., expressed in Hz, number of RB, an index in a table, etc.;
One or more recommended RS profiles for the second RS, each expressed as one or more of: Number of symbols and periodicity; Recommended power profile, expressed, e.g., as any of: An index in a discrete set; A pre-defined field, e.g., ‘uniform’/‘non-uniform; A bitmap of power levels per sub-band, or per group of subcarriers, wherein the size of each sub-band or group of subcarriers may be pre-defined or explicitly indicated; Recommended values of N and M, wherein N is the number of subcarriers in the upper and lower part of the RS profile and M is the separation in subcarriers between the upper and lower parts; Recommended frequency-hopping pattern, e.g., expressed as an index in a pre-defined set of patterns, a list of values of M and D, etc.; Estimated main lobe's accuracy, e.g., expressed as, e.g., the MSE of the ranging profile's main lobe (in m, %, etc.), based on the SNR or RSRPP of the LOS/MPC component being measured; Estimated sidelobe ambiguity, e.g., expressed as the relative sidelobe level with respect to the main lobe in the ranging profile (in dB, natural units, %, etc.) based on the SNR or RSRPP of the LOS/MPC component.

In certain representative embodiments, the main lobe's accuracy and the sidelobe ambiguity values may be represented in a specified digital format (in compressed or uncompressed mode), e.g., as a number of bits or an index in a table of pre-defined values.

In certain representative embodiments, N and M may be obtained from the CRLB of the estimation variance as a function of the SNR. In certain representative embodiments, the WTRU may obtain the values of N and M from the measured SNR and the target MSE, by imposing the condition that the CRLB of the estimation variance cannot exceed the target MSE for localization/sensing. In certain representative embodiments, the CRLB is computed by the WTRU or stored as a set of pre-defined values for different sets of values of N, M and SNR.

In certain representative embodiments, when the likelihood of LOS or single-bounce conditions is below the parameter T configured by the network, the WTRU may constrain N to not exceed the channel's coherence bandwidth. This may have the benefit of allowing velocity estimation by ensuring flat channel conditions over the measurement bandwidth, while not incurring any extra resources that would not lead to improved accuracy in NLOS conditions. The expression of the error variance for localization or sensing in NLOS conditions may be written as

$${ε}_{rms , NLOS}^{2} \geq \frac{{c}^{2}}{{B}_{r m s}^{2} SNR} + \frac{{c}^{2}}{{B}_{c o h}^{2}} ,$$

where c is the speed of light, Bᵣₘₛ is the rms bandwidth of the RS signal, B_{coh} is the channel's coherence bandwidth, and SNR is the signal-to-noise ratio. The last term is caused by the channel's delay spread and usually dominates the overall error, thus making it impractical to increase the signal's bandwidth beyond B_{coh}. In addition, this may allow velocity estimation in NLOS conditions, e.g., based on the analysis of the FM random noise spectrum under flat Rayleigh channel conditions.

In certain representative embodiments, mobility of the WTRU or sensed target may challenge the selection of an RS profile that is tailored to the channel state. However, given that MSE is a statistical long-term measure, the RS profile may be selected according to the averaged channel response over a sufficiently long interval. Depending on the channel's coherence time, this may be closer to the actual channel (under low mobility) or to the average channel (in high mobility). In cases where the channel is highly time-varying, or presents deep fades in frequency, a frequency-hopping pattern may bring added frequency and time diversity so that the RS profile may respond to the average channel state, rather than the instantaneous channel state, and thus overcome the effect of mobility.

In certain representative embodiments, a fast turnaround time may be accomplished by using, e.g., DCI or MAC CE signaling to report one or more pre-configured profiles in a fast way without explicitly reporting their configuration parameters. In certain representative embodiments, the WTRU may store a set of pre-configured lookup tables capturing what the recommended RS profiles are as a function of M, N, SNR, signal BW, channel's coherence bandwidth, target MSE, etc. The WTRU may thus perform a selection without resorting to complex calculations of the CRLB. This, coupled with the use of dynamic signaling based on, e.g., DCI or MAC CE to report the recommended profiles, may achieve a low turnaround time to prevent channel aging effects.

In certain representative embodiments, dynamic signaling may be used by the WTRU to report the profiles based on, e.g., up/down commands issued with reference to a pre-configured lookup table to indicate an RS profile immediately above/before the one currently in use. In certain representative embodiments, signaling may be based on explicit indexes in the pre-configured lookup table. In certain representative embodiments, percentages may be added to the profiles to indicate their relative confidence levels based on the current conditions.

In certain representative embodiments, recommended RS profiles may contain a time duration for their use, e.g., in absolute or relative time units, or a number of slots, subframes, frames, etc.

In certain representative embodiments, achieving a fast turnaround time may not be essential if RS profiles are tailored to the average channel response (e.g., average SNR) and mobility is not too high. In cases when mobility is significant, reporting of frequency-hopping patterns under long-term channel conditions (based on average SNR, coherence BW, etc.) may be leveraged by the WTRU to meet a statistical performance target without stressing the network in terms of the resources needed to achieve a short turnaround time.

### Indication to Perform Localization or Sensing Measurements Based on DL RS Profiles

In certain representative embodiments, the WTRU may receive from the network (via DCI signalling, MAC CE, RRC, etc.) an indication to perform localization or sensing measurements on a second RS based on DL RS profiles.

In certain representative embodiments, the network indication may contain one or more of the following information: DL scheduled resources and shape of the second RS based on DL RS profiles (e.g., including the values of N, M, number of symbols, bandwidth, periodicity, TCI states, antenna ports, etc.); One or more allocated frequency-hopping patterns (e.g., as indexes in a pre-defined set of patterns, a list of values of M and D, etc.); One or more power profiles (e.g., as indexes, a set of fields, e.g., ‘uniform’/‘non-uniform’, one or more bitmaps with power levels per sub-band or per group of subcarriers in dB or natural units, etc.).

In certain representative embodiments, selection of the RS profile may be based on any of the WTRU capabilities, the recommended profiles included in the report for a second RS, and the accuracy of the localization or sensing measurements resulting from application of that profile (e.g., as reported by the WTRU in a previous occasion). In such cases, the network may validate whether the reported accuracy matches the main lobe's accuracy indicated by the WTRU for that profile within the report on the DL RS profiles for a second RS, and in case of a mismatch, override the WTRU recommendation.

### Reporting of Localization or Sensing Measurements Based on DL RS Profiles

In certain representative embodiments, the WTRU may send a report for the localization or sensing measurements performed on the DL scheduled resources of the second RS, containing one or more of the following information given, e.g., in compressed or uncompressed mode or as entries in a table: Antenna ports used in the measurements; Time stamp of the measurements, e.g., in absolute or relative time, or as a number of slots, frames, etc. relative to a known reference; Reference signal resources used in the measurements; One or more scatterer IDs (e.g., a number, a pre-defined label referring to specific peaks in the CIR, etc.); One or more MPC numbers in the CIR; Localization or sensing measurements, e.g., ToA, TDoA, AoA, RSRPP, RSCP, doppler spectrum, RCS, etc., or a range or a statistical distribution of measured values; If more than one antenna port is involved, representative ToA and AoA values can be provided by, e.g., averaging the magnitudes across the antenna ports. ToAs of MPC components for sensing may be reported relative to the ToA of the corresponding LOS component (if present), or in addition to it. AoA values may be reported with respect to a WTRU orientation vector, e.g., a vector perpendicular to the receive antenna panel or any other predefined WTRU surface whose coordinates can also be reported, and may be expressed as, e.g., indexes in a table of predefined directions; Measurement accuracies (e.g., given as the variance or uncertainty in the corresponding magnitudes); In certain representative embodiments, the WTRU may obtain any of the estimated location (e.g., in latitude/longitude, or as coordinates in a suitable reference system, etc.) of the WTRU or the target, its speed, and the estimated object type in sensing (e.g., a label of type ‘car’, ‘pedestrian’, ‘bicycle’, etc.) with the corresponding confidence levels.

In certain representative embodiments, the network may compare any of the reported measurement accuracies with the main lobe's accuracy reported by the WTRU corresponding to the selected RS profile for a second RS. In case of a mismatch, the network may decide to switch to another profile and to override the WTRU recommendation, or to request a profile update to the WTRU. In certain representative embodiments, the network may detect the presence of a mismatch when the sensing accuracy reported by the WTRU as part of the localization or sensing process differs from the accuracy associated to the DL RS profile used by more than a pre-defined or configured tolerance value. In certain representative embodiments, the network may detect a mismatch when the localization or sensing measurements reported by the WTRU are indicative of an error, e.g., a position that does not correspond with the expected WTRU/target position at the estimated velocity. In such case, the network may detect that the actual ambiguity of the RS profile is higher than corresponds for that profile, and the network may override the WTRU report or request a profile update to the WTRU.

In certain representative embodiments, the report may be transmitted in an uplink control or data channel, e.g., a PUCCH or PUSCH, and may be conveyed by, e.g., an RRC control message, UCI signaling, or MAC CE. Reports may be periodic, aperiodic or semi-persistent in accordance to the configuration.

### DL RS Profile Update

In certain representative embodiments, the WTRU may be configured to report measurements for localization or sensing over one or more measurement occasions on a second RS based on DL RS profiles. The WTRU may determine that the indicated DL RS profiles are outdated, or their corresponding measurements invalidated, based on one or more of the following triggering conditions for reporting a DL RS profile update, as provided by the network as part of the WTRU configuration: A change in the uncertainty in any of the sensing metrics above a threshold; A change in the MSE of the position or velocity of any of the WTRU or sensed target, or set of sensed targets, above a threshold; A change in any of the SNR, RSRPP, or LOS/NLOS likelihood for the one or more LOS/MPC components corresponding to the WTRU or sensed targets above a threshold; A change in the channel's coherence bandwidth above a threshold; A change in any of the position or the velocity of the WTRU or the target, or set of sensed targets, above a threshold; A time elapsed since the last reporting of DL RS profiles information exceeding an absolute or relative duration, e.g., a configured periodicity; A WTRU re-configuration message containing updated configuration parameters for reporting of DL RS profiles; A change in the detected RS resources of a second RS, e.g., the birth or death of one or more RS at their configured time-frequency locations, or the corresponding antenna ports; A network request.

Based on any of the above, the WTRU may perform new sensing measurements and send to the network an updated report with the characteristics of the preferred DL RS profiles in an uplink control or data channel containing one of more of the following, e.g., explicitly through an RRC control message, UCI signaling, or MAC CE: Updated Doppler/velocity of any of the WTRU or sensed targets (in Hz, m/s, etc.); Updated SNR or RSRPP of any of the LOS/MPC components being measured (e.g., averaged over a specified or pre-determined time window or over a duration with respect to a given time instant); Updated channel's coherence bandwidth; One or more updated RS profiles for the second RS, each including one or more of: Updated number of symbols and periodicity; Updated power profile; Updated values of N and M, wherein N may be constrained to not exceed the channel's coherence bandwidth when the likelihood of LOS or single-bounce conditions is below T; Updated frequency-hopping pattern; Updated main lobe's accuracy; Updated sidelobe ambiguity.

### DL RS Profile Termination

In certain representative embodiments, the WTRU may be configured to report measurements for localization or sensing over one or more measurement occasions based on DL RS profiles. The WTRU may determine that the indicated DL RS profiles can be terminated for one or more LOS/MPC components, and the WTRU may not further report RS profiles for those ones, based on any of the following triggering conditions for DL RS profile termination, as provided by the network as part of the WTRU configuration: A Doppler or velocity of any of the WTRU or sensed targets outside a range, e.g., a min and a max value; Uncertainty in one or more of the sensing metrics (e.g., ToA, AoA, SNR, RSRPP, RSCP, etc.) of the WTRU or sensed target below a threshold T4 or set of thresholds per each sensing metric; A MSE of the position or velocity of any of the WTRU or sensed targets below a threshold T5; An SNR or RSRPP above a threshold T6 for the one or more LOS/MPC components corresponding to any of the WTRU or sensed targets; A network request containing an indication from the network to fallback to a first RS whose resources are, e.g., determined by the configuration, or explicitly indicated by their BW, no. symbols, periodicity, TCI states, antenna ports, etc.; A time elapsed since the last reporting of DL RS profiles information exceeding a maximum absolute or relative duration; A low-battery indication by the WTRU.

Based on any of the above, the WTRU may terminate the measurements on a second RS based on DL RS profiles.

In certain representative embodiments, e.g., when the termination of DL RS profiles is triggered by the WTRU without an explicit network request, the WTRU may send a control signaling message to the network containing a termination indication, via, e.g., an uplink control or data channel carrying an RRC message, UCI signaling, or MAC CE.

### Transmission of RS Using RS Profiles for Localization and Sensing in UL

In certain representative embodiments, methods and procedures for the transmission by the WTRU of RS profiles for localization and sensing in the UL are provided.

### WTRU Capabilities

In certain representative embodiments, the WTRU may receive and decode a first network request, e.g., received through RRC signalling, to provide capabilities information related to the support in transmission of UL RS profiles for localization and sensing.

In certain representative embodiments, the WTRU may receive and decode this first network request following the random-access procedure.

In certain representative embodiments, the WTRU may prepare a capabilities information message including information related to the support of UL RS profiles for localization and sensing.

The information contained in the WTRU capabilities message may include one or more of the following: sensing transmission capabilities (e.g., inverse frequency transform capabilities, maximum number of samples, etc.); frequency ranges for sensing transmission;

bandwidth for sensing transmission; support for the transmission of a RS for localization or sensing measurements using UL RS profiles, wherein the UL RS profiles are pre-determined and known to the WTRU (e.g., stored in its default configuration/capabilities list); supported frequency-hopping patterns; or supported power profiles.

In certain representative embodiments, the WTRU may send the WTRU capability information message through RRC signalling, e.g., over PUSCH.

In certain representative embodiments, the WTRU capabilities information may be used by the network to optimize its configuration and allocation of UL RS profiles for localization or sensing.

### Configuration of the Transmission Characteristics of a RS Based on UL RS Profile

In certain representative embodiments, the WTRU may receive from the network a configuration message containing the transmission characteristics of a RS using UL RS profiles (via DCI signalling, MAC CE, RRC, etc.). The configuration from the network may take into account the WTRU capabilities related to the support of UL RS profiles in transmission.

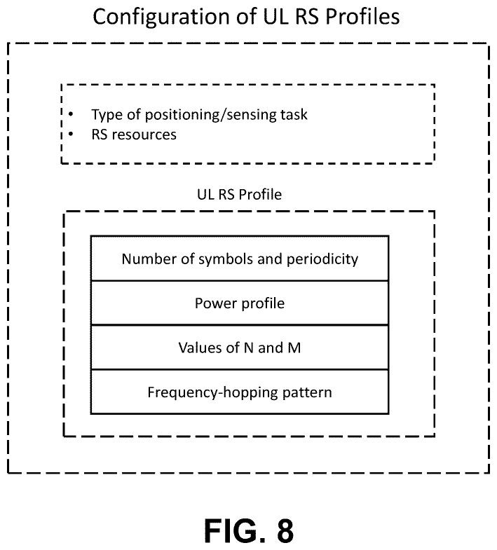

FIG. 8 illustrates contents of the configuration for transmission of UL RS Profiles according to one or more embodiments.

In certain representative embodiments, the configuration from the network contains one or more of the following information, as illustrated in FIG. 8: Type of localization/sensing task, e.g., ‘localization RS transmission’, ‘sensing RS transmission’, etc.;

UL RS scheduled resources (BW, no. symbols, periodicity, TCI states, antenna ports, etc.); UL RS profile characteristics, including one or more of: Number of symbols and periodicity; Selected power profile, expressed, e.g., as any of: An index in a discrete set; A pre-defined field, e.g., ‘uniform’/‘non-uniform; A bitmap of power levels per sub-band, or per group of subcarriers, wherein the size of each sub-band or group of subcarriers may be pre-defined or explicitly indicated. Values of N and M. Allocated frequency-hopping pattern, e.g., expressed as an index in a pre-defined set of patterns, a list of values of M and D, etc.

### Transmission of a RS Based on UL RS Profile

In certain representative embodiments, the WTRU may transmit a RS for localization or sensing based on the UL RS profile indicated in the network request, in the form of, e.g., SRS signal, SRSp signal, dedicated RS for sensing, etc. with the required resources, periodicity, frequency-hopping pattern, and power profile.

### UL RS Profile Termination

In certain representative embodiments, the WTRU may terminate the transmission of a RS using UL RS profiles based on a termination indication received from the network (via DCI signalling, MAC CE, RRC, etc.), or after a pre-defined time interval, number of transmissions, transmission pattern, etc. previously configured by the network. Transmission may terminate immediately upon reception of the termination indication or after a pre-defined, or configured, time interval.

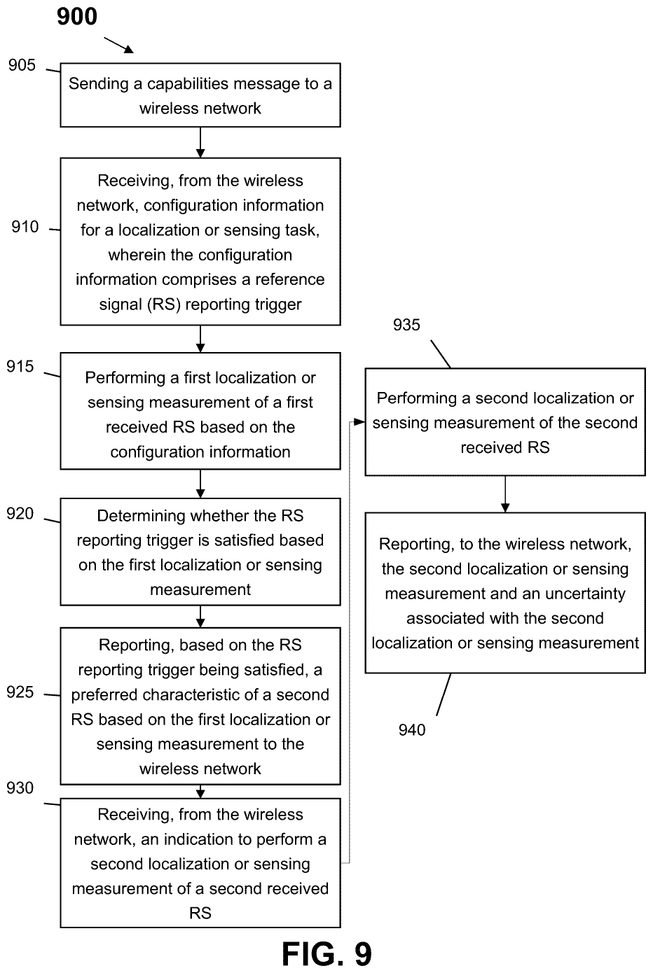

FIG. 9 illustrates a method 900 for selecting and reporting RS profiles in localization or sensing according to one or more embodiments. The method 900 may be performed by a wireless transmit/receive unit (WTRU), such as a WTRU 102 of FIGS. 1A-D and the WTRU of FIG. 2. The method 900 may include sending 905, a capabilities message to a wireless network. In some embodiments, the sending 905 corresponds to step 1 of FIG. 2. The method 900 may include receiving 910, from the wireless network, configuration information for a localization or sensing task, wherein the configuration information comprises a reference signal (RS) reporting trigger. In some embodiments, the receiving 910 corresponds to step 2 of FIG. 2. The method 900 may include performing 915, a first localization or sensing measurement of a first received RS based on the configuration information. In some embodiments, the performing 915 corresponds to step 3 of FIG. 2. The method 900 may include determining 920, whether the RS reporting trigger is satisfied based on the first localization or sensing measurement. In some embodiments, the determining 920 may include comparing the first localization or sensing measurement to one or more thresholds, such as the thresholds T1, T2, and T3 above. The method 900 may include reporting 925, based on the RS reporting trigger being satisfied, one or more preferred characteristics of a second RS based on the first localization or sensing measurement to the wireless network. In some embodiments, the reporting 925 corresponds to step 4 of FIG. 2. The method 900 may include receiving 930, from the wireless network, an indication to perform a second localization or sensing measurement of a second received RS. In some embodiments, the receiving 930 corresponds to step 5 of FIG. 2. The method 900 may include performing 935, a second localization or sensing measurement of the second received RS. The method 900 may include reporting 940, to the wireless network, the second localization or sensing measurement and an uncertainty value associated with the second localization or sensing measurement. In some embodiments, the reporting 940 corresponds to step 6 of FIG. 2.

In some implementations, the second received RS may comprise the one or more preferred characteristics.

In some implementations, the preferred characteristic of the second RS may be based on a first RS profile and the second received RS may comprise characteristic based on a second RS profile, wherein the second RS profile is similar to or different from the first RS profile.

In some implementations, the first RS profile may comprise at least one of a number of symbols and periodicity associated with an RS, a power profile associated with an RS, or a number of subcarriers in an upper part and lower part of the first RS profile and a separation in subcarriers between the upper and the lower part.

In some implementations, the capabilities message may comprise information indicative of at least one of a supported power profile for an RS or a supported frequency-hopping pattern for an RS.

In some implementations, the configuration information may further comprise at least one of available resources for the first RS and the second RS, a power profile of an RS, or a frequency-hopping pattern of an RS.

In some implementations, the RS reporting trigger may comprise at least one of a Doppler range, a velocity range, an uncertainty threshold, a Mean Square Error threshold, or a signal quality threshold.

In some implementations, the method 900 may further comprise determining whether a characteristic of the second received RS is outdated based on an update condition; and in response to determining the characteristic of the second received RS is outdated, reporting, to the network, a report containing an updated preferred characteristic of the second RS. In some embodiments, the reporting, to the network, a report containing an updated preferred characteristic of the second RS corresponds to step 7 of FIG. 2.

In some implementations, the configuration information further may comprise the update condition; and the update condition comprises at least one of an uncertainty threshold associated with the second localization or sensing measurement, a channel's coherence bandwidth threshold associated with the second localization or sensing measurement.

In some implementations, the configuration information may further comprise a termination trigger, and the method 900 may further comprises terminating localization or sensing measurements on the second received RS based on the termination trigger; and sending, to the network, a control signaling message containing a termination indication. In some embodiments, terminating measurements on the second received RS based on the termination trigger corresponds to step 8 of FIG. 2.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

What is claimed is:

1. A method performed by a wireless transmit and/or receive unit (WTRU), comprising:
sending a capabilities message to a wireless network;
receiving, from the wireless network, configuration information for a localization or sensing task, wherein the configuration information comprises a reference signal (RS) reporting trigger;
performing a first localization or sensing measurement of a first received RS based on the configuration information;
determining whether the RS reporting trigger is satisfied based on the first localization or sensing measurement;
reporting, based on the RS reporting trigger being satisfied, one or more preferred characteristics of a second RS based on the first localization or sensing measurement to the wireless network;
receiving, from the wireless network, an indication to perform a second localization or sensing measurement of a second received RS;
performing a second localization or sensing measurement of the second received RS; and
reporting, to the wireless network, the second localization or sensing measurement and an uncertainty value associated with the second localization or sensing measurement.

2. The method of claim 1, wherein the second received RS comprises the one or more preferred characteristics.

3. The method of claim 1, wherein:
the one or more preferred characteristics of the second RS is based on a first RS profile; and
the second received RS comprises characteristic based on a second RS profile,
wherein the second RS profile is similar to or different from the first RS profile.

4. The method of claim 3, wherein the first RS profile comprises at least one of a number of symbols and periodicity associated with an RS, a power profile associated with an RS, or a number of subcarriers in an upper part and lower part of the first RS profile and a separation in subcarriers between the upper and the lower part.

5. The method of claim 1, wherein the capabilities message comprises information indicative of at least one of a supported power profile for an RS or a supported frequency-hopping pattern for an RS.

6. The method of claim 1, wherein the configuration information further comprises at least one of available resources for the first RS and the second RS, a power profile of the second RS, or a frequency-hopping pattern of the second RS.

7. The method of claim 1, wherein the RS reporting trigger comprises at least one of a Doppler range, a velocity range, an uncertainty threshold, a Mean Square Error threshold, or a signal quality threshold.

8. The method of claim 1, further comprising:
determining whether a characteristic of the second received RS is outdated based on an update condition; and
in response to determining the characteristic of the second received RS is outdated, reporting, to the network, a report containing an updated preferred characteristic of the second RS.

9. The method of claim 8, wherein:
the configuration information further comprises the update condition; and
the update condition comprises at least one of an uncertainty threshold associated with the second localization or sensing measurement, a channel's coherence bandwidth threshold associated with the second localization or sensing measurement.

10. The method of claim 1, wherein the configuration information further comprises a termination trigger, and the method further comprises:
terminating localization or sensing measurements on the second received RS based on the termination trigger; and
sending, to the network, a control signaling message containing a termination indication.

11. A wireless transmit/receive unit (WTRU) comprising:
a processer, and
a transceiver coupled to the processer, wherein the WTRU is configured to:
send a capabilities message to a wireless network;
receive, from the wireless network, configuration information for a localization or sensing task, wherein the configuration information comprises a reference signal (RS) reporting trigger;
perform a first localization or sensing measurement of a first received RS based on the configuration information;
determine whether the RS reporting trigger is satisfied based on the first localization or sensing measurement;
report, based on the RS reporting trigger being satisfied, one or more preferred characteristics of a second RS based on the first localization or sensing measurement to the wireless network;
receive, from the wireless network, an indication to perform a second localization or sensing measurement of a second received RS;
perform a second localization or sensing measurement of the second received RS; and
report, to the wireless network, the second localization or sensing measurement and an uncertainty value associated with the second localization or sensing measurement.

12. The WTRU of claim 11, wherein the second received RS comprises the one or more preferred characteristic.

13. The WTRU of claim 11, wherein the one or more preferred characteristic of the second RS is based on a first RS profile; and
the second received RS comprises characteristic based on a second RS profile
wherein the second RS profile is similar to or different from the first RS profile.

14. The WTRU of claim 13, wherein the first RS profile comprises at least one of a number of symbols and periodicity associated with an RS, a power profile associated with an RS, or a number of subcarriers in an upper part and lower part of the first RS profile and a separation in subcarriers between the upper and the lower part.

15. The WTRU of claim 11, wherein the capabilities message comprises information indicative of at least one of a supported power profile for an RS or a supported frequency-hopping pattern for an RS.

16. The WTRU of claim 11, wherein the configuration information further comprises at least one of available resources for the first RS and the second RS, a power profile of the second RS, or a frequency-hopping pattern of the second RS.

17. The WTRU of claim 11, wherein the RS reporting trigger comprises at least one of a Doppler range, a velocity range, an uncertainty threshold, a Mean Square Error threshold, or a signal quality threshold.

18. The WTRU of claim 11, wherein the WTRU is further configured to:
determine whether a characteristic of the second received RS is outdated based on an update condition; and
in response to determining the characteristic of the second received RS is outdated, report, to the network, a report containing an updated preferred characteristic of the second RS.

19. The WTRU of claim 18, wherein:
the configuration information further comprises the update condition; and
the update condition comprises at least one of an uncertainty threshold associated with the second localization or sensing measurement, a channel's coherence bandwidth threshold associated with the second localization or sensing measurement.

20. The WTRU of claim 11, wherein the configuration information further comprises a termination trigger, and the WTRU is further configured to:
terminate localization or sensing measurements on the second received RS based on the termination trigger; and
send, to the network, a control signaling message containing a termination indication.
